(19) United States
(12) Patent Application Publication
(10) Pub. No.: US 2023/0134164 A1
(43) Pub. Date: May 4, 2023

(54) MEANS FOR CONVERTING POST CONSUMER CELLULOSIC TEXTILE WASTE INTO NANOCELLULOSE

(71) Applicants: Revital NADIV, Tel Aviv (IL); Viktoria KANAR, Berlin (DE)

(72) Inventors: Revital NADIV, Tel Aviv (IL); Viktoria KANAR, Berlin (DE)

(21) Appl. No.: 17/976,814

(22) Filed: Oct. 30, 2022

(30) Foreign Application Priority Data
Oct. 29, 2021 (DE) 2021102920512900

(51) Int. Cl. C08J 11/16; D06L 1/14; D06L 4/50

(52) U.S. Cl. CPC C08J 11/16; D06L 1/14; D06L 4/50; C08J 2301/02; D10B 2201/02

(57) ABSTRACT

The present invention discloses means, and systems utilizable in a method for converting post-consumer cellulose-containing (e.g., cotton) textile waste (ctPCR) to nanocellulose, derivatives, and products thereof, comprising steps as follows: grinding said ctPCT; suspending the ground ctPCR in basic pH hydrophilic slurry; and exposing the same to ozone gas.

### FIELD AND BACKGRAOUND OF THE INVENTION

The present invention pertains to modules, systems, and other means utilizable in a method for converting post-consumer cellulose-containing (e.g., cotton) textile waste into nanocellulose, derivatives, and products thereof. The aim of the present inventing is to disclose systems and other means utilizable in a method for ozonation of PCC to yield with nanocellulose.

### SUMMARY OF THE INVENTION

It is one object of the invention to disclose systems, modules, unit operations and other means utilizable in a method for producing nanocellulose from PCC. The means are provided useful for treating a suspension of ground PCC with finely entrained ozone under alkaline conditions followed by well-known acid hydrolysis methods to obtain improved yields and quality of nanocellulose.

Another object of the invention is to disclose a system for converting post-consumer cotton (and other cellulosic fibers) textile waste (ctPCR) to nanocellulose, derivatives, and products thereof, comprising modules as follows: means for de-sizing the ctPCT; means for suspending the ground ctPCR in basic pH hydrophilic slurry, interconnected or otherwise provided in fluid communication with the means of grinding; and ozonating means for exposing the same to ozone, interconnected or otherwise provided in fluid communication with the means of suspending. Additionally, or alternatively, the system further comprising means for sorting out cotton textiles (ctPCR) form post-consumer recyclable waste (PCR). Additionally, or alternatively, the system further comprising means for effectively subjecting suspended slurry to ultrasound waves or otherwise providing the same to mix. Additionally, or alternatively, the system optionally comprising means for hydrolyzing at least one portion of the slurry to obtain the remaining available nanocellulose. Additionally, or alternatively, the system optionally comprising means for converting an amorphous fraction into soluble sugars. Additionally, or alternatively, the means for grinding provides the ctPCR to an average size ranging from about 1 to about 5 mm. Additionally, or alternatively, the system further comprising means for heating the same in a temperature ranging from about 40 to about 90° C. Additionally, or alternatively, the system further comprising means for subjecting the same to a pressure ranging from about 1 bar to about 2.5 bar.

Another object of the invention is to disclose a system as defined in any of the above, wherein the means for suspending the ground ctPCR in basic pH hydrophilic slurry, provides the in a range of about 10.5 to about 14 or more. Additionally, or alternatively, the means for suspending the ground ctPCR in basic pH hydrophilic slurry, provides the same in a range of about 11 to 13. Additionally, or alternatively, the means for exposing to ozone is provided by means of a venturi tube. Additionally, or alternatively, the step of exposing to ozone is provided by means of a diffuser. Additionally, or alternatively, the means for exposing to ozone is provided by providing ozone bubbles in an average size ranging from about 1 to about 300 microns. Additionally, or alternatively, the means for exposing to ozone is provided by providing ozone bubbles in an average size ranging from about 5 and about 50 microns. Additionally, or alternatively, the means for exposing to ozone is provided by providing ozone bubbles in an average size ranging from about 10 and about 30 microns. Additionally, or alternatively, the means for exposing the slurry to ozone gas provided in a rate of about 10 to about 100 mg O₃/g or more. Additionally, or alternatively, the means for exposing the slurry to ozone gas provided in a rate of about 30 to about 80 mg O₃/g. Additionally, or alternatively, the means for exposing the slurry to ozone gas provided in a rate of about 20 to about 40 mg O₃/g.

### BRIEF DESCRIPTION OF THE FIGURE

FIG. 1 and FIG. 2 depict a system a method, respectively, according to some embodiments of the invention.

### DETAILED DESCRIPTION OF THE PREFERRED EMBODIMENTS

The principles and operation of a parking lot according to the present invention may be better understood with reference to the drawings and the accompanying description.

The terms “textile materials” and “textiles” are interchangeably referring various materials as used in the textile industry, for example, fabric, cloth, felt, yarn, thread or webs or strips of material, including, for example, cotton. Yarn can be produced by spinning raw fibers of wool, flax, cotton, hemp, or other materials to produce long strands. Textiles are formed by weaving, knitting, crocheting, knotting, or felting.

The term post-consumer recyclables or “PCR” is a term used in the waste collection/treatment industry to denote all scrap textiles that have value and are recyclable. It is also in the scope of the invention, wherein the term refers to a pelletized material can comprise a biomass base material, such an agricultural or textile waste material and/or by-product. The biomass material can include, for example, any kind of waste or by-product from hemicellulose-containing lignocellulosic materials.

The term “exposing” used herein refer for administering or placing a surface region of a textile in a condition for allowing ozone gas, O₃, to contact with fibers of the surface region and allow an oxidation reaction to be caused with ozone, O₃, between molecules of the fibers of the surface region and ozone, O₃.

As used herein the terms “approximately” and “about” which are used herein throughout interchangeably refer to ±20%.

The phrases “at least one”, “one or more”, and “and/or” are open-ended expressions that are both

The present process/method utilizes an alkaline finely entrained aqueous ozonation pretreatment, resulting in defibrillation and disruption of the amorphous phase of the cotton fibers. This allows for efficient conversion of the PCC to nanocellulose in the subsequent hydrolysis step.

Ozonation of PCC offers a straightforward pretreatment, which uses less space and energy than other intense oxidative treatments. There is little impact on process effluent, since the excess ozone is simply converted to atmospheric oxygen resulting in no harmful oxidative species in the process waste water.

Ozone is generated on-site and on demand, so allowing setting up a micro-factory type facility close to the PCC collection center.

The process/method according to the present invention includes suspending ground PCC in an alkaline water solution (e.g., a hydrophilic slurry) preferably a pH ranging from about 10.5 or less to about 14 or more, more preferably about 11 to 13, and most preferably about 12. Sodium hydroxide, and/or e.g., sodium carbonate, KOH, LiOH, t-butylammonium hydroxide are non-limiting examples of suitable bases.

Grinding of the PCC is required to create a large surface area for ozone interaction. Suitable average size in a range of about 1 to about 5 mm, preferably about 2 mm.

Suspension in the aqueous alkaline media may be facilitated by addition of high-molecular-weight polymers, soaps or deflocculating agents (generally electrolytes) into the slurry of the PCC.

The suspension is treated with a finely entrained ozone gas, produced, for example, by a venturi tube. The bubble size is between about 1 to about 300 micrometers, more preferably, between about 5 and about 50 microns and most preferably between about 10 and about 30 microns.

The slurry is treated with ozone in a range of about 10 or less to about 100 mg O₃/g or more, with some preferred embodiments being in a range of, for example, about 30 to about 80 mg O₃/g or in a range of about 20 to about 40 mg O₃/g. The optimal concentration is determined by the measured average molecular weight of the incoming biomass as well as its crystalline to amorphous ratio.

It is in the scope of the invention wherein at least a portion of the suspension is optionally shaken, vibrated, subjected to ultrasound waves, vibrated, spun, milled, de-sized, dispersed, pulverized, admixed or otherwise effectively mixed (hereinafter “mixed” or “mixing”).

The solid material treated with ozone is separated from the suspension by common sedimentation or floatation methods practiced in the paper and sewage treatment industries. Any nanocellulose present in the aqueous phase is separated by ultrafiltration.

It is also in the scope of the invention wherein a separated slurry is hydrolyzed using common methods to obtain the remaining available nanocellulose. The remainder, mostly previously amorphous fraction, is converted into soluble sugars. The sugars in the filtrate may be fermented using common methods to obtain fermentation products, including e.g., man of animal edible products, nutraceuticals, products and by-products utilizable in cosmetic and pharmaceuticals etc.

It is also in the scope of the invention wherein the above defined system is configured to operated in a method set forth for converting post-consumer cotton (and other cellulosic fibers) textile waste (ctPCR) to nanocellulose, derivatives, and products thereof, comprising one or more steps r otherwise the steps in an order as follows: (a) grinding the ctPCT; (b) suspending the ground ctPCR in basic pH hydrophilic slurry; and (c) exposing the same to ozone.

Considering aforesaid method, an embodiment is that the method further comprising step or steps of sorting out cotton textiles (ctPCR) form post-consumer recyclable waste (PCR). Additionally, or alternatively, the method further comprising step of effectively subjecting suspended slurry to ultrasound waves or otherwise providing the same to mix. Additionally, or alternatively, the method optionally comprising step of hydrolyzing at least one portion of the slurry to obtain the remaining available nanocellulose. Additionally, or alternatively, the method optionally comprising step of converting an amorphous fraction into soluble sugars. Additionally, or alternatively, the step of grinding provides the ctPCR to an average size ranging from about 1 to about 5 mm. Additionally, or alternatively, the method further comprising step of heating the same in a temperature ranging from about 40 to about 90° C. Additionally, or alternatively, the method further comprising step of subjecting the same to a pressure ranging from about 1 bar to about 2.5 bar. Additionally, or alternatively, the step of suspending the ground ctPCR in basic pH hydrophilic slurry, provided in a range of about 10.5 to about 14 or more. Additionally, or alternatively, the step of suspending the ground ctPCR in basic pH hydrophilic slurry, provided in a range of about 11 to 13. Additionally, or alternatively, the step of exposing to ozone is provided by means of a venturi tube. Additionally, or alternatively, the step of exposing to ozone is provided by means of a diffuser. Additionally, or alternatively, the step of exposing to ozone is provided by providing ozone bubbles in an average size ranging from about 1 to about 300 microns. Additionally, or alternatively, the step of exposing to ozone is provided by providing ozone bubbles in an average size ranging from about 5 and about 50 microns. Additionally, or alternatively, the step of exposing to ozone is provided by providing ozone bubbles in an average size ranging from about 10 and about 30 microns. Additionally, or alternatively, the step of exposing the slurry to ozone gas provided in a rate of about 10 to about 100 mg O₃/g or more. Additionally, or alternatively, the step of exposing the slurry to ozone gas provided in a rate of about 30 to about 80 mg O₃/g. Additionally, or alternatively, the step of exposing the slurry to ozone gas provided in a rate of about 20 to about 40 mg O₃/g.

### Example I

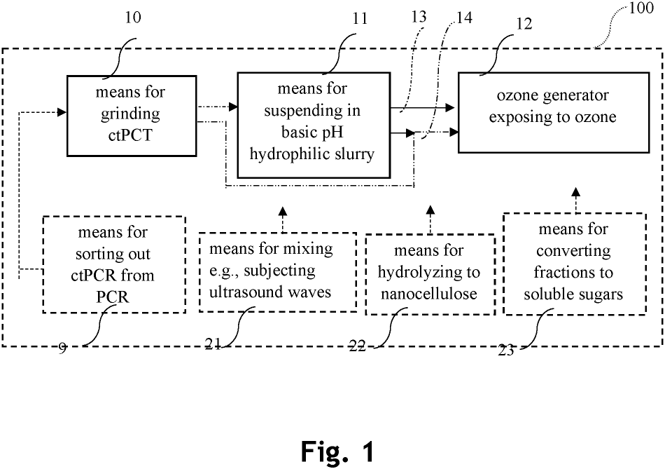

Reference is now made to FIG. 1, schematically illustrating in a non-limiting manner system (100) provided useful for the conversion post-consumer cotton textile waste (ctPCR) to nanocellulose, derivatives, and products thereof. The system comprises, inter alia, module (10) or several modules for de-sizing the ctPCT. The system also comprises module (11) or several modules for suspending said ground ctPCR in basic pH hydrophilic slurry. Optionally, it is interconnected or otherwise provided in fluid communication with one or more modules (11) for de-sizing. The system further comprises one or more modules (12) for exposing the slurry to ozone. Optionally, it is interconnected or otherwise provided in fluid communication (13) with one or more the suspending means (11) or both (14) one or more grinding and suspending means (10,11). Optionally, the grinding module(s) is in connection with a sorter (9). Still optionally, modules (10-12), each or all, are in in connection with mixer (21), hydrolyzer (22) and or converter (23).

It is according to one embodiment of the invention, wherein the grinding modules is configured to reduce the size of the ctPCR to an average size ranging from about 0.5 to about 3 mm. Various commercially available cutting, shredding, atomizing, slicing milling, pulverizing and grinding modules are applicable. Another embodiment of the invention discloses de-sizing module(s) configured with effective means to reduce the size of the ctPCR to an average size ranging from about 3 to about 6 mm.

It is according to one embodiment of the invention, wherein one, some or all of the modules are provided with heating means, configured for providing the slurry to a temperature ranging from about 40 to about 90° C.

It is according to one embodiment of the invention, wherein one, some or all of the modules are provided with compressing means, configured for providing the slurry to a pressure ranging from about 1 bar to about 2.5 bar.

It is according to one embodiment of the invention, wherein one, some or all of the modules are configured to be operative under basic (alkaline) pH conditions. Hence for example, the pH of the treated slurry is a range of. about 9 to about 11 or more. According to another embodiment of the invention, pH range between about 11 to about pH 14 or more. It is according to yet other embodiments of the invention, wherein pH buffers, e.g., buffer potassium borate (pH 9), glycine-sodium hydroxide buffer (pH 10), di-sodium hydrogen phosphate/sodium hydroxideare (pH 12), Potassium chloride/Sodium hydroxide (pH 13) are used.

It is according to one embodiment of the invention wherein ozone is exposed to the slurry by means of a venturi injector, venturi-type educator, venturi-type pump, or any other effective ozone emitting nozzle or an array of nozzles suitable for outflowing pressurized ozone stream of bubbles.

It is according to one embodiment of the invention wherein ozone bubbles are characterized by a predefined average size; i.e., bubble diameter ranging from about 1 to about 300 microns. According to yet another embodiment, bubbles average diameter is ranging from (i) about 5 and about 50 microns, or (ii) from about 10 and about 30 microns.

It is according to one embodiment of the invention wherein ozone gas provided in a rate of about 10 to about 100 mg O₃/g or more. According to yet another embodiment, ozone gas is provided in a rate of (i) about 30 to about 80 mg O₃/g, or (ii) a rate of about 20 to about 40 mg O₃/g or more.

### Example II

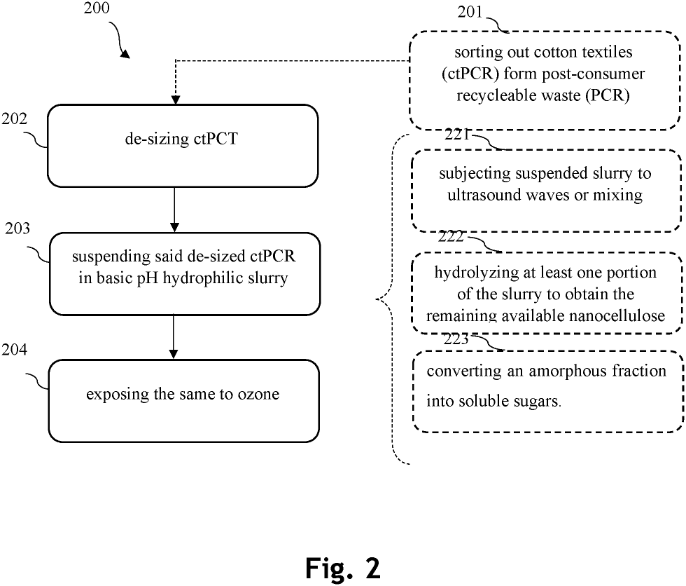

Reference is now made to FIG. 2, schematically illustrating in a non-limiting manner a method (200) for converting post-consumer cotton textile waste (ctPCR) to nanocellulose, derivatives, and products thereof. The method comprises, inter alia, steps of de-sizing (202) said ctPCT; suspending (203) said ground ctPCR in basic pH hydrophilic slurry; and (204) exposing the same to ozone. A step of sorting (201) PCR to extract or otherwise obtain ctPCR is optional. Other steps, e.g., subjecting to mixing (221), hydrolyzing (222) and/or converting the same to useful products such as sugars (223) are potentially applicable.

Process temp. can range from 25 to 90° C.

### Example III

1 kg of PCC was ground to average size of about 3 mm using a lab blade grinder (Ika Batch mill). The ground PCC was dispersed in a stirred 30 \-liter volume ozonation vessel using 25 liters of deionized water and 0.5% by weight of wetting agent (Avco-Wet DZ, AvcoChem). The pH was adjusted to 12 using Sodium hydroxide. The stirred slurry temperature was set at 40C. Ozone was introduced to the vessel using a venturi tube at 30 mg O₃/g. The average bubble size was 20 microns. The ozonation proceeded for about 20 minutes at atmospheric pressure. The slurry was then decanted and the coarse solids were separated using a lab centrifuge. Nanocellulose was separated from the liquid phase by well-known flocculation/filtration techniques using aluminum sulfate as the flocculant.

The yield was about 35% by weight of the original biomass. The obtained nanofibrils were less than about 100 nm in width and less than about 1500 nm in length.

### Example IV

The coarse solids of Example 3 were subjected to well-known sulfuric acid hydrolysis techniques. Nanocellulose was separated from the liquid phase by well-known flocculation/filtration techniques using aluminum sulfate as the flocculant. The yield was a further about 12% of the original biomass. The obtained nanofibrils were less than about 50 nm in width and less than about 100 nm in length.

### Example V

The process of Example 4 was performed on 1 Kg of stirred slurry that has not subjected to the ozonation step of Example 3. The nanocellulose yield was 2 about 6% of the original biomass. The obtained nanofibrils were less than about 50 nm in width and less than about 100 nm in length.

We claim:

1. A system for converting post-consumer cellulosic textile waste, including cotton including wastes (both denoted “ctPCR”) to nanocellulose, derivatives, and products thereof, the system comprising :
a. means for de-sizing said ctPCT;
b. means for suspending said ground ctPCR in basic pH hydrophilic slurry, interconnected or otherwise provided in fluid communication with said means of de-sizing; and
c. ozonating means for exposing the same to ozone, interconnected or otherwise provided in fluid communication with said means of suspending.

2. The system of claim 1, further comprising means for sorting out cotton textiles (ctPCR) form post-consumer recyclable waste (PCR).

3. The system of claim 1, further comprising means for effectively subjecting suspended slurry to ultrasound waves or otherwise providing the same to mix.

4. The system of claim 1, optionally comprising means for hydrolyzing at least one portion of the slurry to obtain the remaining available nanocellulose.

5. The system of claim 1, optionally comprising means for converting an amorphous fraction into soluble sugars.

6. The system of claim 1, wherein said means for de-sizing provides said ctPCR to an average size ranging from about 1 to about 5 mm.

7. The system of claim 1, said system further comprising means for heating the same in a temperature ranging from about 40 to about 90° C.

8. The system of claim 1, further comprising means for subjecting the same to a pressure ranging from about 1 bar to about 2.5 bar.

9. The system of claim 1, wherein said means for suspending said ground ctPCR in basic pH hydrophilic slurry, provides the in a range of about 10.5 to about 14 or more.

10. The system of claim 1, said means for suspending said ground ctPCR in basic pH hydrophilic slurry, provides the same in a range of about 11 to 13.

11. The system of claim 1, wherein said means for exposing to ozone is provided by means of a venturi tube.

12. The system of claim 1, wherein said means for exposing to ozone is provided by providing ozone bubbles in an average size ranging from about 1 to about 300 microns.

13. The system of claim 1, wherein said means for exposing to ozone is provided by providing ozone bubbles in an average size ranging from about 5 and about 50 microns.

14. The system of claim 1, wherein said means for exposing to ozone is provided by providing ozone bubbles in an average size ranging from about 10 and about 30 microns.

15. The system of claim 1, wherein said means for exposing the slurry to ozone gas provided in a rate of about 10 to about 100 mg O₃/g or more.

16. The system of claim 1, wherein said means for exposing the slurry to ozone gas provided in a rate of about 30 to about 80 mg O₃/g.

17. The system of claim 1, wherein said means for exposing the slurry to ozone gas provided in a rate of about 20 to about 40 mg O₃/g.
